(19) United States
(12) Patent Application Publication
(10) Pub. No.: US 2013/0258384 A1
(43) Pub. Date: Oct. 3, 2013

(54) SERVER SYSTEM, PRINT SYSTEM, AND PRINTER

(71) Applicant: SHARP KABUSHIKI KAISHA, Osaka (JP)

(72) Inventor: Takayuki KANOH, Osaka-shi (JP)

(73) Assignee: Sharp Kabushiki Kaisha, Osaka (JP)

(21) Appl. No.: 13/848,187

(22) Filed: Mar. 21, 2013

(30) Foreign Application Priority Data
Mar. 27, 2012 (JP) 2012-072202

(51) Int. Cl. G06F 3/12

(52) U.S. Cl. CPC G06F 3/1297
USPC 358/1.13

(57) ABSTRACT

A communication control unit transmits a request for shortening a polling time interval to a printer after a web UI unit has accepted a print instruction about a data file and before generation of a print file by a print file acquiring unit is completed.

### BACKGROUND OF THE INVENTION

1. Field of the Invention

The present invention relates to a print system including a printer and a server system that converts a data file to be printed into a print file which is interpretable by the printer and that transmits the print file to the printer, and also relates to the server system and printer included in the print system.

2. Description of the Related Art

Hitherto, print systems have been available. In such a print system, a printer and a server device (server system) that transmits a data file (document file, image file, or the like) to be printed to the printer are connected to each other via a communication network so that the printer and the server device are capable of communicating with each other. The server device transmits a print job including a print file to the printer, and accordingly the printer executes printing (so-called push printing via the server device).

In such a print system, in a case where a printer is connected to an intranet protected by a firewall, it is generally difficult for a server device outside the firewall to start communication with the printer. That is, in order to enable the server device outside the firewall to start communication with the printer connected to an intranet, it is necessary to individually perform changing of a setting of the firewall, a port forward setting of a router, and so forth. Therefore, it is practically difficult for the server device to start communication with the printer.

For the above-described reason, in a case where the printer is connected to an intranet protected by a firewall, the following method is adopted: the printer polls the server device at a certain time interval, and thereby the printer serves as a client, acquires a print file from the server device, and performs printing on the print file.

For example, Japanese Unexamined Patent Application Publication No. 2006-227854 discloses the following technique as a technique for monitoring the progress of a print job which has been requested from a server device to a printer. The printer polls the server device at a standard polling interval (about 30 seconds), acquires a print job from the server device, and starts the print job. After that, the server device transmits a request for shortening the polling interval to the printer in response to the polling which is performed at the standard polling interval. That is, according to the technique disclosed in the above-mentioned publication, the server device transmits a request for shortening the polling interval to the printer in response to the polling which is performed after a print job has been transmitted from the server device to the printer. Accordingly, the interval of the polling performed by the printer thereafter is set to a short polling interval (about 5 second), which is shorter than the standard polling interval. Then, the server device transmits a request for transmitting a print status in response to the polling which is performed at the short polling interval, and thereby acquires and monitors the progress of the print job in the printer at a shorter time interval.

However, in the technique disclosed in the above-mentioned publication, the time period from when a user provides an instruction to execute printing to when print processing starts in the printer is not shortened, though the progress of printing can be monitored at a short time interval after printing has started in the printer.

That is, in the technique disclosed in the above-mentioned publication, the polling interval is set to the short polling interval after a print job has been started, but the polling interval is set to the standard polling interval before a print job is started. Thus, in a case where the user provides an instruction to execute printing during a period starting from when polling is performed to when a next polling is performed after the standard polling interval, the printer can recognize the existence of the print job corresponding to the instruction only after performing the next polling and acquiring a response to the polling. Accordingly, a time lag arises from when the user provides an instruction to execute printing to when print processing starts.

To shorten the time period from when a print execution instruction is provided to when print processing starts, the standard polling interval may be set to be short from the start. In that case, however, the load of transmitting polling signals in the printer and the load of responding to the polling signals in the server device increase. Particularly, in a case where a single server device manages many printers, even if the load of responding to polling signals from one printer is small, the overall load is not negligible.

### SUMMARY OF THE INVENTION

In view of the above-described problems, preferred embodiments of the present invention shorten a print processing time while significantly reduce or prevent an increase in the processing load of a server system.

A server system according to a preferred embodiment of the present invention includes a communication control unit, an instruction accepting unit, and a print file acquiring unit. The communication control unit controls communication with one or plural printers. The instruction accepting unit accepts a print instruction about a data file. The print file acquiring unit generates or acquires a print file, the print file being generated by converting the data file corresponding to the print instruction into data which is interpretable by a certain printer, among the one or plural printers, that is to perform print processing on the data file. The server system transmits the print file to the certain printer in response to data received from the certain printer. The certain printer polls the server system at a certain time interval. The communication control unit transmits a request for shortening a polling time interval to the certain printer after the instruction accepting unit has accepted the print instruction about the data file. The server system may be constituted by a single device or plural devices that are connected so as to be capable of communicating with one another. The server system may also be constituted by hardware device(s) or a combination of hardware device(s) and software executed thereon.

With this configuration, after the instruction accepting unit has accepted the print instruction about the data file, the communication control unit transmits the request for shortening the polling time interval to the certain printer. Accordingly, the time interval of the polling performed by the certain printer can be shortened, and thus the print file which has been generated or acquired by the print file acquiring unit can be quickly transmitted to the certain printer. Accordingly, a print processing time can be shortened. On the other hand, the polling time interval of a printer for which a print instruction has not been accepted is set to the certain time interval (a time interval longer than in a case where a print instruction has been accepted). Thus, an increase in the processing load of the server system caused by shortening the polling time interval can be significantly reduced or prevented. Therefore, the print processing time can be shortened while significantly reducing or preventing an increase in the processing load of the server system.

The communication control unit may transmit the request for shortening the polling time interval to the certain printer in response to a polling signal, in a case where the communication control unit receives the polling signal from the certain printer after the instruction accepting unit has accepted the print instruction about the data file and before preparation for transmitting the print file corresponding to the data file is completed.

With this configuration, the time interval of the polling performed by the certain printer can be shortened, and thus the print file can be quickly transmitted to the certain printer when preparation for transmitting the print file is completed.

The instruction accepting unit may accept the print instruction from a client device that is connected to the server system so as to be capable of communicating with the server system.

With this configuration, a print system in which a server system accepts a print instruction from a client device, converts a data file corresponding to the accepted print instruction into a print file, and transmits the print file to a printer. As a result, a print processing time can be shortened while significantly reducing or preventing an increase in the processing load of the server system.

The print file acquiring unit may acquire the print file from a client device that is connected to the server system so as to be capable of communicating with the server system.

With this configuration, in a print system in which a print file generated by a client device is transmitted to a printer and the printer is caused to execute print processing, a print processing time can be shortened while significantly reducing or preventing an increase in the processing load of a server system.

A print system according to another preferred embodiment of the present invention includes the above-described server system, and a printer that executes print processing on a print file which is transmitted from the server system.

With this configuration, a print processing time can be shortened while significantly reducing or preventing an increase in the processing load of the server system.

The printer may start print preprocessing to bring the printer into a printing executable state, after receiving a request for shortening a polling time interval from the server system and before receiving the print file.

With this configuration, print preprocessing can be performed before the printer receives the print file, and thus print processing can be quickly started after the print file has been generated, and a print processing time can be further shortened.

A printer according to another preferred embodiment of the present invention includes a communication control unit, an instruction input unit, and an image forming unit. The communication control unit controls communication with a server system. The instruction input unit accepts input of an instruction from a user. The image forming unit prints an image corresponding to a print file. The communication control unit polls the server system at a certain time interval. When the instruction input unit accepts a start instruction to start operating in a processing mode in which a print file to be printed is acquired from the server system and print processing is executed on the print file, the communication control unit makes a polling time interval for the server system shorter than before the start instruction is accepted.

With this configuration, the print file can be quickly transmitted from the server system to the printer. Thus, a print processing time can be shortened. In a case where the processing mode is not selected, the polling time interval is set to the certain time interval (a time interval longer than in a case where the processing mode is selected), and thus an increase the processing load of the server system caused by shortening the polling time interval can be significantly reduced or prevented. Therefore, the print processing time can be shortened while significantly reducing or preventing an increase in the processing load of the server system.

As described above, with the server system and the print system according to various preferred embodiments of the present invention, the print processing time can be shortened while significantly reducing or preventing an increase in the processing load of the server system.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an explanatory diagram illustrating a schematic configuration of a print system according to a preferred embodiment of the present invention.

FIG. 2 is an explanatory diagram illustrating an example of a document file management table used in the print system illustrated in FIG. 1.

FIG. 3 is an explanatory diagram illustrating an example of a printer management table used in the print system illustrated in FIG. 1.

FIG. 4 is an explanatory diagram illustrating an example of a print job management table used in the print system illustrated in FIG. 1.

FIG. 5 is an explanatory diagram illustrating the relationship between values which are possible in a status field of the print job management table illustrated in FIG. 4 and statuses represented by the individual values.

FIG. 6 is a flowchart illustrating the flow of print processing in the print system illustrated in FIG. 1.

FIG. 7 is a sequence diagram of a polling process which is performed between a printer and a document management server in a case where input of a print instruction from a user is not performed in the print system illustrated in FIG. 1.

FIG. 8 is a sequence diagram of a polling process which is performed between the printer and the document management server in a case where input of a print instruction from a user is performed in the print system illustrated in FIG. 1.

FIG. 9 is a sequence diagram of a polling process which is performed between the printer and the document management server in a case where a user provides an instruction to select a document file via a client device and then operates the printer to cause the printer to execute print processing in the print system illustrated in FIG. 1.

FIG. 10 is a sequence diagram of a polling process which is performed between the printer and the document management server in a case where a polling time interval is shortened when the printer accepts a certain operation from a user in the print system illustrated in FIG. 1.

FIG. 11 is a sequence diagram of a polling process which is performed between the printer and the document management server in a case where the client device transmits a print file to the document management server, and the document management server transmits the print file to the printer and causes the printer to execute print processing in the print system illustrated in FIG. 1.

### DETAILED DESCRIPTION OF PREFERRED EMBODIMENTS

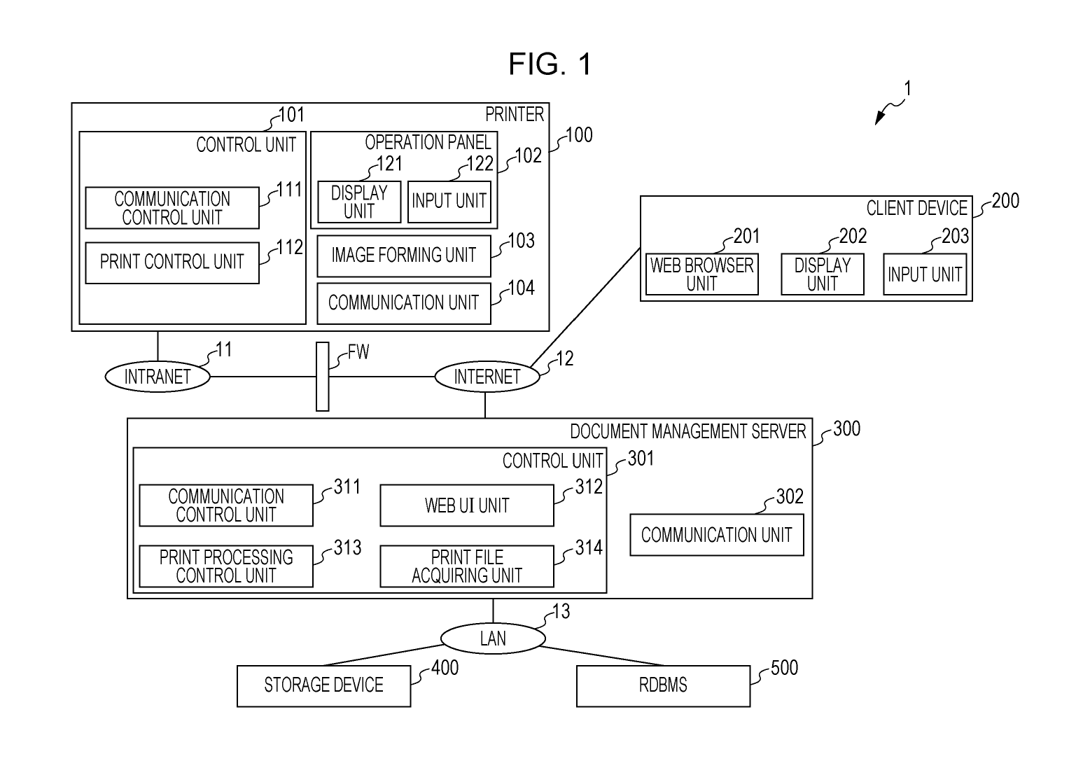

Preferred embodiments of the present invention will be described. FIG. 1 is an explanatory diagram illustrating a schematic configuration of a print system 1 according to a first preferred embodiment of the present invention.

As illustrated in FIG. 1, the print system 1 includes a printer 100, a client device 200, a document management server (server system) 300, a storage device (storage) 400, and a relational database management system (RDBMS) 500. The printer 100 is connected to an intranet 11 which is protected by a firewall FW, and the intranet 11 is connected to the Internet 12 via the firewall FW. The client device 200 and the document management server 300 are connected to the Internet 12. The storage device 400 and the RDBMS 500 are connected to the document management server 300 via a local area network (LAN).

In the example illustrated in FIG. 1, one printer 100 and one client device 200 are preferably provided, for example. Alternatively, plural printers 100 and plural client devices 200 may be connected to the document management server 300 via the Internet 12.

The printer 100 includes a control unit 101, an operation panel (instruction input unit) 102, an image forming unit 103, and a communication unit 104. The control unit 101 includes a communication control unit 111 and a print control unit 112.

The operation panel 102 is a user interface that provides various pieces of information to a user and that accepts input from the user and transmits it to the control unit 101. The operation panel 102 includes an input unit 122 including various input keys, and a display unit 121 constituted by, for example, a liquid crystal display (LCD) or the like. The configurations of the input unit 122 and the display unit 121 are not particularly limited. For example, the input unit 122 and the display unit 121 may be integrated together to form a touch panel.

The image forming unit 103 forms (prints) an image corresponding to image data on a recording material, such as paper. The configuration of the image forming unit 103 is not particularly limited. For example, an electrophotographic image forming device, an inkjet image forming device, or the like may be used as the image forming unit 103.

The communication unit 104 is a network interface that communicates with the document management server 300 via the intranet 11 and the Internet 12, in accordance with an instruction provided from the control unit 101.

The control unit 101 is a computer device constituted by a processing unit, such as a central processing unit (CPU) or a dedicated processor, and a storage unit, such as a random access memory (RAM), a read only memory (ROM), and a hard disk drive (HDD), which are not illustrated, and is programmed to perform the functions of the control unit 101 described herein. More specifically, the control unit 101 reads out various pieces of information and executes a program or programs for executing various control operations, which are stored in the storage unit, and executes the program or programs to realize the functions of the communication control unit 111 and the print control unit 112.

The communication control unit (polling process unit) 111 polls the document management server 300 via the communication unit 104. Specifically, the printer 100 is assigned with a serial number which identifies the printer 100. The communication control unit 111 notifies the document management server 300 of the serial number of the printer 100 via the communication unit 104, and determines whether or not the document management server 300 has data to be transmitted to the printer 100 (a print file to be printed by the printer 100, various processing requests to the printer 100, and so forth). In a case where the document management server 300 has data to be transmitted to the printer 100, the communication control unit 111 acquires the data which is transmitted from the document management server 300 in response to polling. In a case where the data received from the document management server 300 is a request for changing a polling interval, the communication control unit 111 changes the time interval from the preceding polling to the next polling, in accordance with the request.

The print control unit 112 controls the operation of the image forming unit 103 on the basis of a print file (print data) which has been acquired by the communication control unit 111 from the document management server 300, and causes the image forming unit 103 to form an image corresponding to the print file on a recording material.

The client device 200 is connected to the document management server 300 via the Internet 12 so as to be capable of communicating with the document management server 300. The client device 200 includes a web browser unit 201, a display unit 202, and an input unit 203. The client device 200 may be a personal computer, or a mobile terminal such as a smart phone, for example.

The web browser unit 201 executes a web browser application, and thereby accesses a web user interface (UI) unit 312 of the document management server 300, and performs a process of displaying an image acquired from the document management server 300 on the display unit 202 and a process of transmitting various pieces of data to the document management server 300.

Specifically, the web browser unit 201 acquires a display screen showing a list of document files (data files) managed by the document management server 300 from the document management server 300, and causes the display unit 202 to display the display screen. Also, the web browser unit 201 transmits, to the document management server 300, a selection instruction to select a document file to be printed from the list displayed on the display unit 202 and a print instruction to print the selected document file, the instructions being input by a user via the input unit 203.

Also, the web browser unit 201 uploads a document file to be managed by the document management server 300 from the client device 200 to the document management server 300, in accordance with a user instruction input via the input unit 203.

The client device 200 is a computer device which is constituted by a processing unit, such as a CPU or a dedicated processor, and a storage unit, such as a RAM, a ROM, and an HDD, which are not illustrated, and is programmed to perform the functions of the client device 200 described herein. More specifically, the client device 200 reads out various pieces of information and a program or programs for executing various control operations, which are stored in the storage unit, and executes the program or programs to realize the functions of the web browser unit 201.

The document management server (server system) 300 includes a control unit 301 and a communication unit 302. The control unit 301 includes a communication control unit 311, the web UI unit (instruction accepting unit) 312, a print processing control unit 313, and a print file acquiring unit 314. The document management server 300 may be constituted by a single device, or may be constituted by plural devices which are connected so as to be capable of communicating with one another. The document management server 300 may also be constituted by hardware device(s) or a combination of hardware device(s) and software executed thereon.

The communication unit 302 is a network interface that communicates with another device connected via the Internet 12 in accordance with an instruction provided from the control unit 301. The communication unit 302 has a function of communicating with the storage device 400 and the RDBMS 500 which are connected via the LAN 13 in accordance with an instruction provided from the control unit 301.

The control unit 301 is a computer device constituted by a processing unit, such as a CPU or a dedicated processor, and a storage unit, such as a RAM, a ROM, and an HDD, which are not illustrated, and is programmed to perform the functions of the control unit 301 described herein. More specifically, the control unit 301 reads out various pieces of information and a program or programs for executing various control operations, which are stored in the foregoing storage unit, and executes the program or programs to realize the functions of the communication control unit 311, the web UI unit 312, the print processing control unit 313, and the print file acquiring unit 314.

The communication control unit (polling response unit) 311 accepts and responds to polling performed by the printer 100. Specifically, a polling signal from the printer 100 includes the serial number of the printer 100, and the communication control unit 311 performs a preset response process in accordance with the serial number. The communication control unit 311 has a function of changing the content of a polling response for a specific printer in accordance with a notification received from the print processing control unit 313. The communication control unit 311 communicates with the storage device 400 and the RDBMS 500 in accordance with an instruction provided from the print processing control unit 313.

The web UI unit 312 performs a process in accordance with a user operation transmitted from the web browser unit 201 of the client device 200. For example, the web UI unit 312 performs a process of accepting a document file which has been uploaded from the client device 200, a process of transmitting data of a display screen showing a list of document files managed by the document management server 300 to the client device 200, and a process of accepting a selection instruction and print instruction for a document file to be printed from a user.

The web UI unit 312 may perform a user authentication process for a user who has accessed via the client device 200. Also, among the document files managed by the document management server 300, a document file which can be viewed or printed by a user who has accessed via the client device 200 may be limited on a user by user basis.

The print processing control unit 313 performs a process (for example, status management of print processing) in conjunction with the individual devices included in the print system 1, in accordance with a user instruction accepted by the web UI unit 312 from the client device 200.

Specifically, for example, in a case where the web UI unit 312 accepts a request for transmitting a display screen showing a list of document files managed by the document management server 300, the print processing control unit 313 transmits the data of the display screen to the client device 200 via the communication unit 302.

In a case where the web UI unit 312 accepts a selection instruction and print instruction for a document file to be printed, the print processing control unit 313 acquires the document file from the storage device 400, and causes the print file acquiring unit 314 to generate a print file having a data format which is interpretable by the printer 100. Then, the print processing control unit 313 transmits the generated print file and a print instruction to print an image corresponding to the print file to the printer 100 via the communication unit 302. Note that transmission of the print file and print instruction from the document management server 300 to the printer 100 is performed in response to the data received from the printer 100 (polling signal, print processing start request, and so forth).

In the present preferred embodiment, in a case where the print processing control unit 313 accepts a selection instruction and print instruction for a document file to be printed from the client device 200, the print processing control unit 313 transmits a request for changing a polling interval to the printer 100 in response to the polling performed by the printer 100. The details of the process of changing a polling interval will be described below.

The print file acquiring unit 314 performs a process of converting a document file into a print file having a data format which is interpretable by the printer 100 that prints the document file, in accordance with an instruction provided from the print processing control unit 313.

The storage device 400 stores document files managed by the document management server 300, print files, print jobs, printer information, and so forth. The configuration of the storage device 400 is not particularly limited, and may be in the form of being connected to a network (LAN 13), for example, a network attached storage (NAS) or a storage attached network (SAN), or may be in the form of being directly connected to the document management server 300, for example, a direct attached storage (DAS). Alternatively, the storage device 400 may be provided in the document management server 300.

The RDBMS 500 accepts a processing request for acquisition, update, addition, or deletion of various pieces of data from the print processing control unit 313 of the document management server 300, and performs a process in accordance with the processing request. For example, the RDBMS 500 manages data about the document files stored in the storage device 400, the printer provided in the print system 1, the print job to be executed by the print system 1, and status information about the print job.

Specifically, the RDBMS 500 includes a document file management table, a printer management table, and a print job management table, refers to these tables in accordance with an instruction provided from the print processing control unit 313, and performs a process in accordance with the instruction.

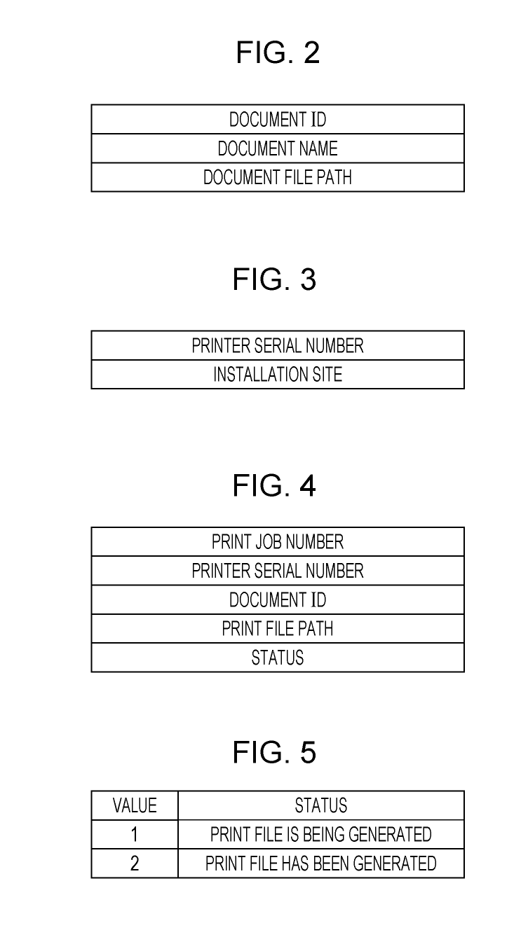

FIG. 2 is an explanatory diagram illustrating an example of the document file management table used in the RDBMS 500. As illustrated in FIG. 2, the RDBMS 500 manages the document files stored in the storage device 400 by using the document file management table showing the document IDs and document names of the document files, and the paths of sites where the document files are stored.

FIG. 3 is an explanatory diagram illustrating an example of the printer management table used in the RDBMS 500. As illustrated in FIG. 3, the RDBMS 500 manages individual printers by using the printer management table showing the serial numbers and installation sites (for example, address information) of the individual printers provided in the print system 1.

FIG. 4 is an explanatory diagram illustrating an example of the print job management table used in the RDBMS 500. As illustrated in FIG. 4, the RDBMS 500 generates a print job management table including individual fields (items) of a print job number, a printer serial number, a document ID, a print file path (print data path), and a status, for each print job generated by the print processing control unit 313 of the document management server 300 every time the user of the client device 200 provides a print instruction, and manages the print jobs on the basis of the print job management table. FIG. 5 illustrates the relationship between the values which are possible in the status field of the print job management table illustrated in FIG. 4 and the statuses represented by the individual values.

The RDBMS 500 preferably is software which is installed into a server computer or the like, and the CPU or the like of the server computer performs processing in accordance with the program or programs. The RDBMS 500 may operate in a device connected to the document management server 300 via the LAN 13, or may operate in the document management server 300. As the RDBMS 500, software according to the related art may be used, for example.

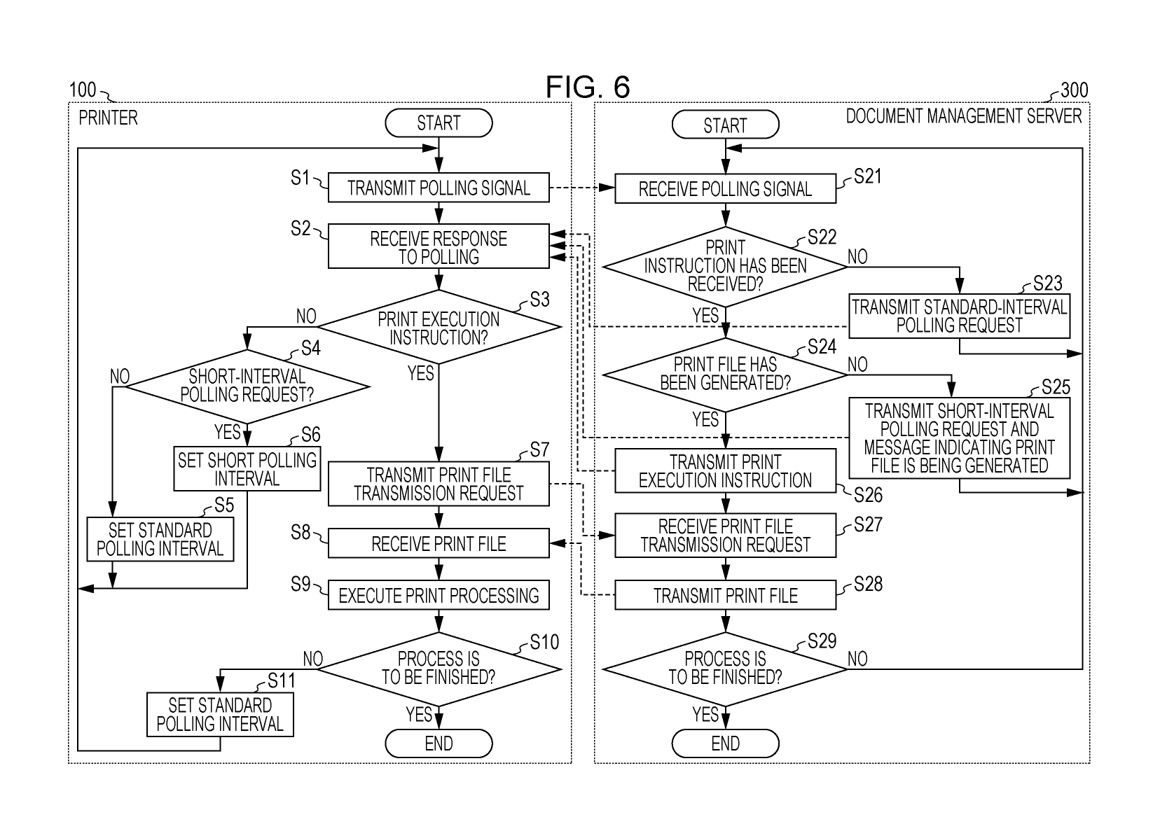

Next, the flow of print processing performed in the print system 1 will be described. FIG. 6 is a flowchart illustrating the flow of the process performed by the printer 100 and the document management server 300 in the print processing in the print system 1.

In step S1, the communication control unit 111 of the printer 100 transmits a polling signal to the document management server 300 via the communication unit 104 at a certain polling interval. In the initial state, the polling interval (the time interval of polling) is set to a standard polling interval (for example, 30 seconds).

The communication unit 302 of the document management server 300 receives the polling signal from the printer 100 in step S21, and then the communication control unit 311 of the document management server 300 determines whether or not a print instruction from the client device 200 to the printer 100 has been received (whether or not a print job corresponding to the printer 100 exists in the print job management table managed by the RDBMS 500) in step S22.

When the user of the client device 200 logs into the document management server 300 via the web browser unit 201 and provides a print instruction to cause the specific printer 100 to print a document managed by the document management server 300, the web UI unit 312 provides the information thereof to the print processing control unit 313. The print processing control unit 313 requests the RDBMS 500 to add print job information to the print job management table, and transmits a request for generating a print file to the print file acquiring unit 314.

The print file acquiring unit 314 which has received the request starts a process of converting the document file corresponding to the print instruction from the user into a print file which is interpretable by the printer corresponding to the print instruction, in accordance with the information in the print job management table managed by the RDBMS 500. The print file acquiring unit 314 queues print jobs in the order they were accepted, and sequentially generates print files. After the print file has been generated, the print file acquiring unit 314 transmits a processing request to the RDBMS 500 so as to set the file path of the generated print file and a status value of 2 (print file has been generated) in the print job management table (update the print job management table).

Upon receiving the polling signal from the printer 100, the communication control unit 311 notifies the RDBMS 500 of the printer serial number which is included in the polling signal, and requests search for a print job corresponding to the printer 100. On the basis of a search result obtained from the RDBMS 500, the communication control unit 311 determines whether or not the print job corresponding to the printer 100 exists, and also determines a status value if the print job exists.

If it is determined in step S22 that the print instruction for the printer 100 has not been received (the print job corresponding to the printer 100 does not exist in the print job management table), the communication control unit 311 transmits a standard-interval polling request (“no print job/polling interval of 30 seconds”) to the printer 100 via the communication unit 302 in step S23.

On the other hand, if it is determined in step S22 that the print instruction for the printer 100 has been received (the print job corresponding to the printer 100 exists in the print job management table), the communication control unit 311 determines in step S24 whether or not the print file corresponding to the print instruction has been generated, on the basis of the status value of the corresponding print job in the print job management table.

If it is determined in step S24 that the print file has not been generated, the communication control unit 311 transmits a short-interval polling request (request for shortening the polling time interval) and a message indicating that the print file is being generated (“print job is being generated/polling interval of 5 seconds”) to the printer 100 via the communication unit 302 in step S25.

If it is determined in step S24 that the print file has been generated, the communication control unit 311 transmits a print execution instruction to the printer 100 via the communication unit 302 in step S26.

Upon receiving a response to polling from the document management server 300 in step S2, the communication control unit 111 of the printer 100 determines whether or not the response includes a print execution instruction in step S3.

If it is determined in step S3 that the response does not include a print execution instruction, the communication control unit 111 determines whether or not the response from the document management server 300 includes a short-interval polling request in step S4.

If it is determined in step S4 that the response does not include a short-interval polling request, the communication control unit 111 sets the polling time interval to the standard polling interval in step S5. Then, the process returns to step S1, where the communication control unit 111 transmits a polling signal again at the time when the time period corresponding to the standard polling interval has elapsed from the preceding transmission of a polling signal.

On the other hand, if it is determined in step S4 that the response includes a short-interval polling request, the communication control unit 111 sets the polling time interval to the short polling interval (for example, 5 seconds) in step S6. Then, the process returns to step S1, where the communication control unit 111 transmits a polling signal again at the time when the time period corresponding to the short polling interval has elapsed from the preceding transmission of a polling signal. At this time, the communication control unit 111 may notify the print control unit 112 that a print file is being generated in the document management server 300, and the print control unit 112 may perform print preprocessing so that print processing can be quickly started when the print file is received from the document management server 300. Examples of the print preprocessing include (i) in a case where the printer 100 is an electrophotographic printer, a process of changing the mode from a preheating mode (a mode in which the temperature of a fixing member provided in a fixing device is kept at a certain standby temperature lower than a temperature for printing) to a normal mode (a mode in which the temperature of the fixing member provided in the fixing device is set to the temperature for printing), (ii) in a case where the printer 100 is an inkjet printer, a process of cleaning nozzles from which ink is ejected, and a process of adjusting a head position, (iii) a calibration process, (iv) a process of checking a remaining amount of a recording material used for printing, such as paper, (v) a process of checking a remaining amount of a color material used for printing (toner or ink), (vi) a process of checking the operation of individual members and individual sensors provided in the printer 100, and combinations of these processes.

If it is determined in step S3 that the response includes a print execution instruction, the communication control unit 111 instructs the print control unit 112 to start print processing, and the print control unit 112 transmits a print file transmission request to the document management server 300 via the communication unit 104 in step S7.

The print processing control unit 313 of the document management server 300 receives the print file transmission request from the printer 100 in step S27, and then requests the RDBMS 500 to search for a print file. Specifically, the print processing control unit 313 notifies the RDBMS 500 of the serial number of the printer 100, causes the RDBMS 500 to search for a print job having a status value of 2 (a print file has been generated) among the print jobs corresponding to the printer, and causes the RDBMS 500 to notify the print processing control unit 313 of the file path of the print file corresponding to the print job.

Subsequently, the print processing control unit 313 instructs the communication control unit 311 to transmit the print file to the printer 100. Accordingly, in step S28, the communication control unit 311 transmits the print file which has been generated by the print file acquiring unit 314 to the printer 100 via the communication unit 302. Subsequently, the print processing control unit 313 requests the RDBMS 500 to delete, from the print job management table, the print job corresponding to the print file which has been transmitted to the printer 100, and determines whether or not the process is to be finished. If the process is not to be finished, the process returns to step S21, where reception of a polling signal is waited for.

The print control unit 112 of the printer 100 receives the print file from the document management server 300 in step S8, and then controls the operation of the image forming unit 103 and causes the image forming unit 103 to execute print processing in step S9, so as to form (print) an image corresponding to the received print file on a recording material.

Subsequently, the print control unit 112 determines in step S10 whether or not the process is to be finished. If the process is not to be finished, the polling interval is set to the standard polling interval in step S11, and the process returns to step S1.

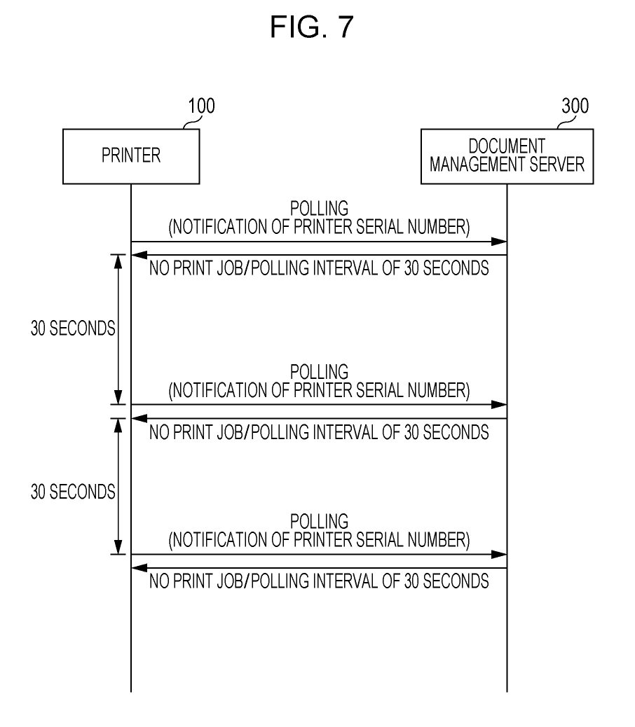

FIG. 7 is a sequence diagram of a polling process which is performed between the printer 100 and the document management server 300 in a case where input of a print instruction from a user is not performed on the client device 200.

The communication control unit 111 of the printer 100 performs polling (print file confirmation polling) at the certain standard polling interval (in the present preferred embodiment, 30 seconds, for example), and notifies the document management server 300 of the serial number of the printer 100.

The communication control unit 311 of the document management server 300 notifies the RDBMS 500 of the serial number notified from the printer 100, and causes the RDBMS 500 to search the print job management table for a print job corresponding to the printer 100. If there is no print job corresponding to the printer 100 in the print job management table, the communication control unit 311 transmits a standard-interval polling request (“no print job/polling interval of 30 seconds”) which is set by default to the printer 100 in response to polling. Accordingly, polling is repeated at the standard polling interval.

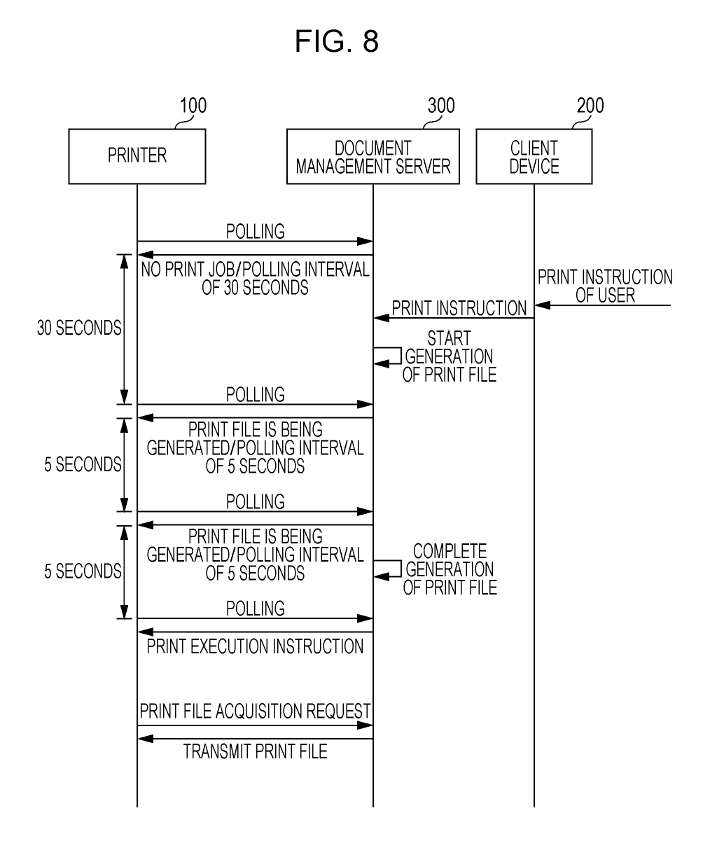

FIG. 8 is a sequence diagram of a polling process which is performed between the printer 100 and the document management server 300 in a case where input of a print instruction from a user is performed on the client device 200. The print instruction from the user input to the client device 200 is transmitted to the web UI unit 312 of the document management server 300 via the web browser unit 201.

The communication control unit 111 of the printer 100 performs polling (print file confirmation polling) at the certain standard polling interval (in the present preferred embodiment, 30 seconds, for example), and notifies the document management server 300 of the serial number of the printer 100.

The communication control unit 311 of the document management server 300 notifies the RDBMS 500 of the serial number notified from the printer 100, and causes the RDBMS 500 to search the print job management table for a print job corresponding to the printer 100 and the status of the print job. If there is a print job corresponding to the printer 100 in the print job management table and if the status of the print job is “a print file is being generated”, the communication control unit 311 transmits a short-interval polling request (“print job is being generated/polling interval of 5 seconds”) to the printer 100 in response to polling. Accordingly, the printer 100 polls the document management server 300 after the time period corresponding to the short polling interval has elapsed (5 seconds after the preceding polling).

If a print job corresponding to the printer 100 which has transmitted a polling signal exists in the print job management table and if the status of the print job is “a print file has been generated”, the communication control unit 311 of the document management server 300 transmits a print execution instruction to the printer 100 in response to the polling signal. Accordingly, a print file transmission request is transmitted from the printer 100 to the document management server 300. In response to the print file transmission request, a print file (print job including a print file) is transmitted from the document management server 300 to the printer 100, and printing is executed.

As described above, in the print system 1 according to the present preferred embodiment, the document management server 300 sets the polling interval for the subsequent polling performed by the printer 100 in accordance with whether or not a print job corresponding to the printer 100 exists, when receiving a polling signal from the printer 100.

Accordingly, the polling interval is set to be shorter than usual (short polling interval) in a case where a print job to be printed by the printer 100 exists. As a result, the time period from when generation of a print file is completed to when the printer 100 acquires the print file can be shortened. Thus, the time period from when the user provides an instruction to start print processing to when the print processing is actually started in the printer 100 can be shortened.

Also, a polling process is performed at a relatively long interval (standard polling interval) in a normal condition where there is no print job to be executed by the printer 100. Accordingly, an increase in load of the polling process imposed on the printer 100 and the document management server 300, and an increase in communication traffic can be suppressed.

In the present preferred embodiment, preferably the client device 200 connected to the document management server 300 so as to be capable of communicating with the document management server 300 provides a print instruction (an instruction to select a document file to be printed, and an instruction to select a printer that is to perform print processing), but the present invention is not limited thereto.

For example, an instruction accepting unit (not illustrated) that accepts an operation instruction from a user may be provided in the document management server 300, and the user may provide the above-described print instruction via the instruction accepting unit.

In the present preferred embodiment, the user of the client device 200 preferably inputs an instruction to select a document file to be printed and a printer that is to execute print processing via the client device 200, and the document management server 300 causes the printer corresponding to the instruction to execute print processing (so-called push printing), but the present invention is not limited thereto.

For example, after the user of the client device 200 has instructed the document management server 300, via the client device 200, to select a document file to be printed without specifying the printer as a destination of the document file, the user may acquire (download) the print file corresponding to the selected document file from the document management server 300 by operating an arbitrary printer 100, and may cause the printer 100 to print the print file (so-called pull printing).

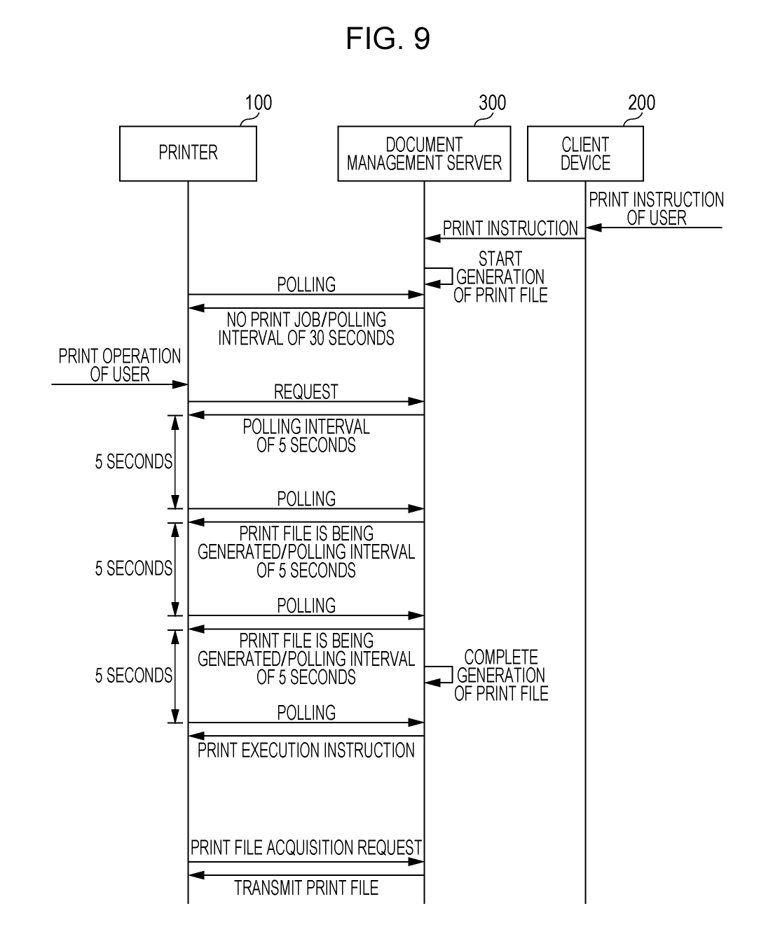

FIG. 9 is a sequence diagram of a polling process which is performed between the printer 100 and the document management server 300 in a case where a user provides an instruction to select a document file via the client device 200 and then operates the printer 100 to acquire a print file and causes the printer 100 to print the print file.

When the user of the client device 200 provides an instruction to select a document file to be printed (print instruction), the content of the instruction is transmitted to the web UI unit 312 of the document management server 300 via the web browser unit 201, and is transmitted from the web UI unit 312 to the print processing control unit 313. The print processing control unit 313 requests the RDBMS 500 to add print job information to the print job management table, and requests the print file acquiring unit 314 to generate a print file. The print file acquiring unit 314 that has accepted the request starts a process of converting the document file corresponding to the print instruction from the user into a print file which is interpretable by the printer corresponding to the print instruction, in accordance with the information in the print job management table managed by the RDBMS 500. After the print file has been generated, the print file acquiring unit 314 transmits a processing request to the RDBMS 500 so as to set the file path of the generated print file and a status value of 2 (print file has been generated) in the print job management table (update the print job management table).

The communication control unit 111 of the printer 100 polls the document management server 300 at the certain polling interval (in the initial state, the standard polling interval (e.g., 30 seconds)).

Even in a case where a print instruction has been received from the client device 200 and generation of a print file has been started, the communication control unit 311 of the document management server 300 transmits a standard-interval polling request (“no print job/polling interval of 30 seconds”) in response to the polling performed by the printer 100, until receiving a print request from the printer 100 (notification indicating that the user has provided an instruction to start print processing on a data file by using the operation panel 102 of the printer 100).

Upon accepting an operation to start print processing from a user (specification of a print job and an output instruction), which is input via the operation panel 102, the communication control unit 111 of the printer 100 transmits a print request to the document management server 300 via the communication unit 104.

Upon receiving the print request or a polling signal from the printer 100, the communication control unit 311 of the document management server 300 determines whether or not the print file corresponding to the print instruction has been generated on the basis of the status value of the corresponding print job in the print job management table. If the print file has not been generated, the communication control unit 311 transmits a short-interval polling request and a message indicating that a print file is being generated (“print job is being generated/polling interval of 5 seconds”) to the printer 100 via the communication unit 302. If the print file has been generated, the communication control unit 311 transmits a print execution instruction to the printer 100 via the communication unit 302.

When the communication control unit 111 of the printer 100 receives a short-interval polling request from the document management server 300, the communication control unit 111 performs polling thereafter at the short polling interval. When the communication control unit 111 receives a print execution instruction from the document management server 300, the communication control unit 111 instructs the print control unit 112 to start print processing, and the print control unit 112 transmits a print file transmission request to the document management server 300 via the communication unit 104. Accordingly, the print control unit 112 acquires a print file, and controls the operation of the image forming unit 103 to cause the image forming unit 103 to execute printing.

In the present preferred embodiment, the document management server 300 preferably transmits a request for shortening the polling time interval to the printer 100, but the present invention is not limited thereto. For example, the printer 100 may shorten the polling time interval when a certain operation is performed on the printer 100 by a user.

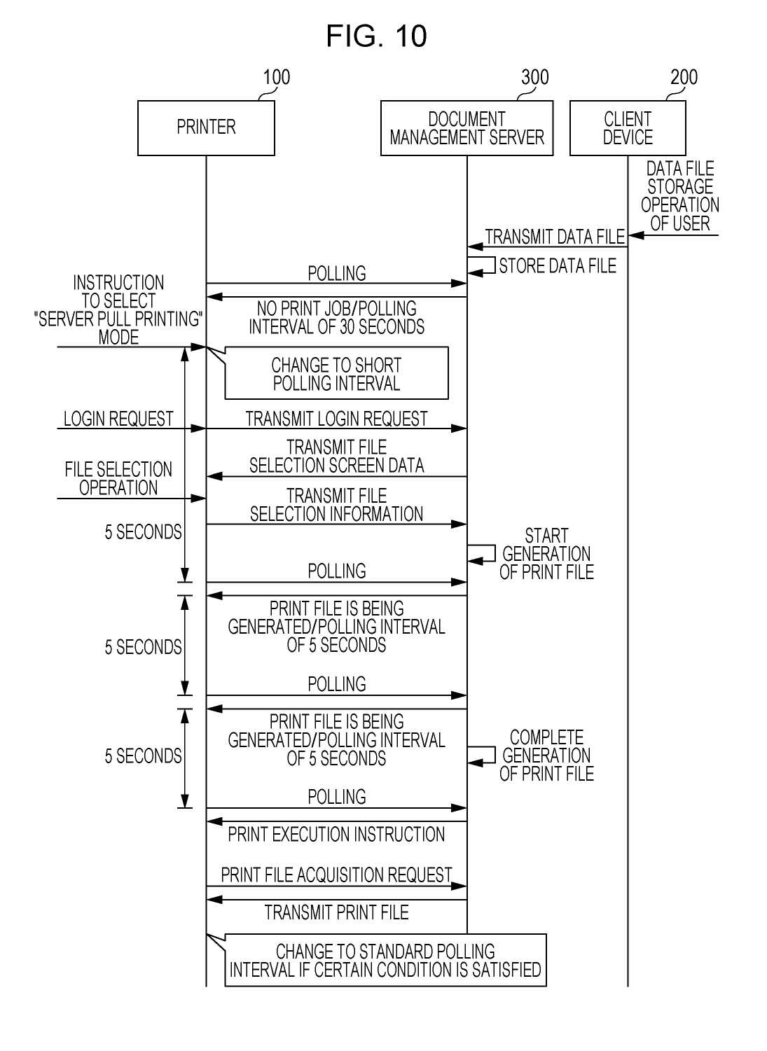

FIG. 10 is a sequence diagram of a polling process which is performed between the printer 100 and the document management server 300 in a case where the polling time interval is shortened when an instruction to start a “server pull printing” mode is accepted, which is a processing mode in which the printer 100 acquires a print file to be printed from the document management server 300 and executes print processing.

As illustrated in FIG. 10, a data file corresponding to an instruction provided from the user of the client device 200 is stored in advance in the document management server 300. That is, when the user of the client device 200 performs a data file storage operation to store a data file in the document management server 300, the data file is transmitted from the client device 200 to the document management server 300, and the document management server 300 stores the data file received from the client device 200 in the storage device 400.

Upon accepting an instruction to start operating in the “server pull printing” mode from the user, which is input via the operation panel 102, the communication control unit 111 of the printer 100 sets the polling time interval for the document management server 300 to the short polling interval (in the present preferred embodiment, 5 seconds, for example), which is shorter than the standard polling interval (in the present preferred embodiment, 30 seconds, for example) before the start instruction is accepted. The instruction to start operating in the “server pull printing” mode may be provided by, for example, including a function selection icon of “server pull printing” in a menu screen which is displayed on the display unit 121 of the operation panel 102 and selecting the icon by the user.

After that, upon accepting a login request from the user which is input via the operation panel 102, the communication control unit 111 of the printer 100 transmits information corresponding to the login request to the document management server 300. Upon accepting the login request from the printer 100, the control unit 301 of the document management server 300 transmits the screen data of a file selection screen used for selecting a data file to be printed to the printer 100.

At the time of requesting login, a user authentication process may be performed to determine whether or not login is to be permitted, and only when login is to be permitted, the screen data of the file selection screen may be transmitted to the printer 100. The user authentication process may be performed in the following manner, for example. The user inputs authentication information (for example, a user name and a password) via the operation panel 102 of the printer 100, or inputs authentication information by causing the printer 100 to read an IC card or the like, and the printer 100, the document management server 300, or another device connected via the Internet 12 performs the user authentication process by using the authentication information.

The control unit 101 of the printer 100 causes the display unit 121 to display a display screen corresponding to the screen data of the file selection screen received from the document management server 300, and accepts an operation of selecting a file to be printed, which is performed on the operation panel 102 by the user. Upon accepting the operation of selecting a file from the user, the communication control unit 111 of the printer 100 transmits file selection information for specifying the selected file to the document management server 300. Upon receiving the file selection information from the printer 100, the document management server 300 causes the print file acquiring unit 314 to start a process of converting the data file corresponding to the file selection information into a print file on which print processing is to be executed by the printer 100.

After generation of the print file (preparation for transmitting the print file) has been completed, the document management server 300 transmits a print execution instruction to the printer 100 in response to a polling signal or other data received from the printer 100. Accordingly, the printer 100 transmits a print file acquisition request to the document management server 300, and the document management server 300 transmits the print file to the printer 100, and then print processing is executed.

In a case where a certain condition is satisfied after the printer 100 has received the print file from the document management server 300, the communication control unit 111 of the printer 100 may change the polling time interval to the standard polling interval. Examples of the certain condition include (i) when the printer 100 has completed the process of receiving a print file, (ii) when print processing for the print file in the printer 100 has been completed, (iii) when the user has performed a logout process by using the operation panel 102, and (iv) when a state where a user operation is not performed on the operation panel 102 continues for a certain time period (for example, 5 minutes).

According to the present preferred embodiment, the print file acquiring unit 314 of the document management server 300 preferably converts a document file to be printed into a print file having a data format which is interpretable by the printer 100, but the present invention is not limited thereto. For example, the print file acquiring unit 314 may acquire a print file from another device (for example, the client device 200) connected to the document management server 300 so as to be capable of communicating with the document management server 300.

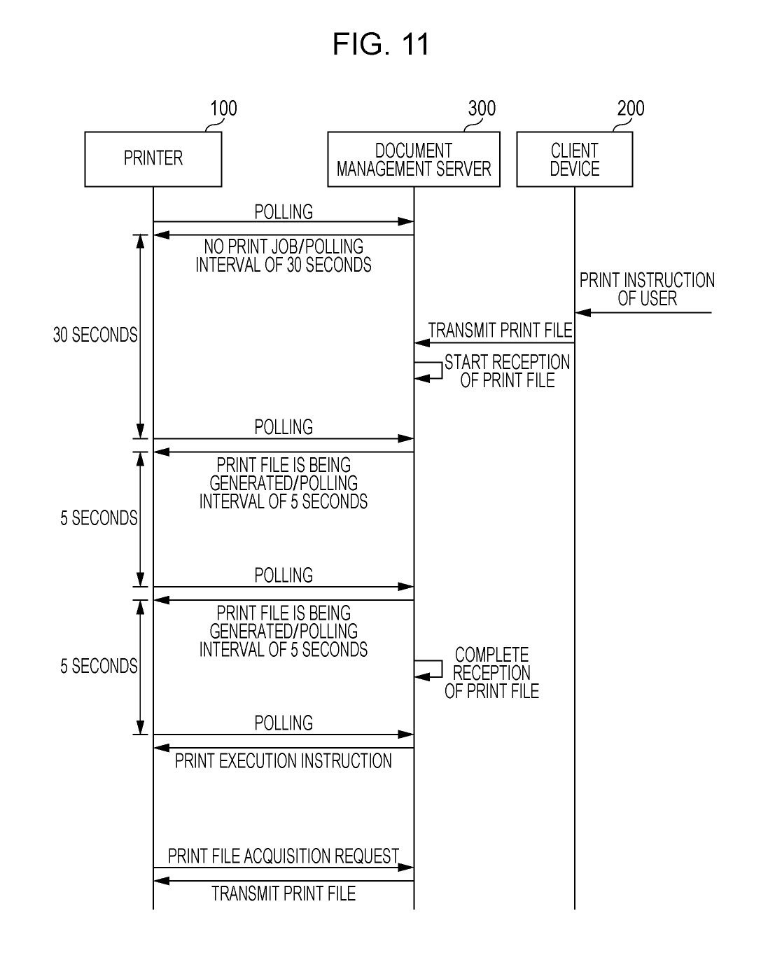

FIG. 11 is a sequence diagram of a polling process which is performed between the printer 100 and the document management server 300 in a case where a print control unit (printer driver, not illustrated) of the client device 200 generates a print file and transmits the print file to the document management server 300, and the document management server 300 transmits the print file to the printer 100 and causes the printer 100 to execute print processing.

The print control unit of the client device 200 converts a data file corresponding to a print instruction provided from a user into a print file which is interpretable by the printer 100, and transmits the print file and the serial number of the printer that is to execute print processing on the print file to the document management server 300. When the communication control unit 311 of the document management server 300 detects the start of transmission of the print file from the client device 200, the communication control unit 311 starts a process of receiving the print file. The received print file may be stored in, for example, the storage device 400, or may be stored in a memory (not illustrated) provided in the document management server 300.

The communication control unit 111 of the printer 100 performs polling (print file confirmation polling) at the certain standard polling interval (in the present preferred embodiment, 30 seconds, for example), and notifies the document management server 300 of the serial number of the printer 100.

The communication control unit 311 of the document management server 300 determines whether or not a print file corresponding to the serial number, which is indicated in a polling signal from the printer 100, is being received. If the print file is being received, the communication control unit 311 transmits a short-interval polling request to the printer 100 in response to the polling signal. Accordingly, the printer 100 polls the document management server 300 after the time period corresponding to the short polling interval has elapsed.

In a case where reception of a print job corresponding to the printer 100 which has transmitted a polling signal has been completed, the communication control unit 311 of the document management server 300 transmits a print execution instruction to the printer 100 in response to the polling signal. Accordingly, a print file transmission request is transmitted from the printer 100 to the document management server 300. In response to the print file transmission request, a print file is transmitted from the document management server 300 to the printer 100, and printing is executed.

In the present preferred embodiment, the individual control units provided in the printer 100 and the document management server 300 (the control unit 101 and the control unit 301) preferably may be achieved by a software program that is executed by a processor, such as a CPU, for example. In this case, the printer 100 and the document management server 300 include a CPU that executes commands of a control program that realizes individual functions, a ROM that stores the control program, a RAM to which the control program is loaded, and a storage device (recording medium) that stores the control program and various pieces of data, such as a memory. The advantageous effects of various preferred embodiments of the present invention may be achieved by supplying the printer 100 and the document management server 300 with a computer-readable recording medium containing the program code of the control program for the printer 100 and the document management server 300 (for example, execution format program, intermediate code program, and source program), which is software for realizing the above-described functions, and reading and executing the program code recorded on the recording medium by the computer (or CPU or microprocessing unit (MPU)) of the printer 100 and the document management server 300.

Non-limiting examples of the above-described recording medium include tapes such as a magnetic tape and a cassette tape; disks including magnetic disks such as a floppy (registered trademark) disk and a hard disk, and optical discs such as a compact disc read only memory (CD-ROM), a magneto-optical (MO) disc, a MiniDisc (MD), a digital versatile disc (DVD), and a compact disc recordable (CD-R); cards such as an IC card (including a memory card) and an optical card; and semiconductor memories such as a mask ROM, an erasable programmable ROM (EPROM), an electrically erasable programmable ROM (EEPROM), and a flash ROM.

The printer 100 and the document management server 300 may be configured to be connectable to a communication network, and the above-described program code may be supplied thereto via the communication network. The communication network is not particularly limited, and may be, for example, the Internet, an intranet, an extranet, a LAN, an integrated services digital network (ISDN), a value added network (VAN), a cable television (CATV) communication network, a virtual private network, a telephone line network, a mobile communication network, a satellite communication network, or the like. A transmission medium constituting the communication network is not particularly limited, and may be, for example, a wired transmission medium such as IEEE 1394, a universal serial bus (USB), a power line carrier, a cable TV line, a telephone line, or an asymmetric digital subscriber line (ADSL); or a wireless transmission medium such as infrared of Infrared Data Association (IrDA) or a remote control, Bluetooth (registered trademark), IEEE 802.11, high data rate (HDR), a mobile phone network, satellite connection, or a terrestrial digital network. The preferred embodiments of the present invention may also be realized in the form of a computer data signal embedded in carrier waves, in which the above-described program code is embodied by electronic transmission.

The individual blocks of the printer 100 and the document management server 300 are not necessarily realized using software. For example, the individual blocks may be constituted by hardware logic, or may be a combination of hardware that performs a portion of the processing and a processing unit for executing software that controls the hardware and performs the other portion of the processing.

The present invention is not limited to the above-described preferred embodiments, and various changes can be made within the scope of the attached claims. That is, a preferred embodiment achieved by combining technical elements and features which are appropriately modified within the scope of the attached claims is also included in the technical scope of the present invention.

Various preferred embodiments of the present invention can be applied to a print system including a printer and a server system that converts a data file to be printed into a print file which is interpretable by the printer and that transmits the print file to the printer, and to the server system and printer included in the print system.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A server system comprising:
a communication control unit programmed to control communication with one or plural printers;
an instruction accepting unit programmed to accept a print instruction about a data file; and
a print file acquiring unit programmed to generate or acquire a print file, the print file being generated by converting the data file corresponding to the print instruction into data which is interpretable by a certain printer, among the one or plural printers, that is to perform print processing on the data file; wherein
the server system transmits the print file to the certain printer in response to data received from the certain printer;
the certain printer polls the server system at a certain time interval; and
the communication control unit is programmed to transmit a request for shortening a polling time interval to the certain printer after the instruction accepting unit has accepted the print instruction about the data file.

2. The server system according to claim 1, wherein the communication control unit transmits the request for shortening the polling time interval to the certain printer in response to a polling signal received by the communication control unit from the certain printer after the instruction accepting unit has accepted the print instruction about the data file and before preparation to transmit the print file corresponding to the data file is completed.

3. The server system according to claim 1, wherein the instruction accepting unit is programmed to accept the print instruction from a client device that is connected to the server system so as to be capable of communicating with the server system.

4. The server system according to claim 1, wherein the print file acquiring unit is programmed to acquire the print file from a client device that is connected to the server system so as to be capable of communicating with the server system.

5. A print system comprising:
the server system according to claim 1; and
a printer operatively connected to the server system to execute print processing on a print file which is transmitted from the server system.

6. The print system according to claim 5, wherein the printer includes an instruction input unit programmed to start print preprocessing to bring the printer into a printing executable state, after receiving a request for shortening a polling time interval from the server system and before receiving the print file.

7. A printer comprising:
a communication control unit programmed to control communication with a server system;
an instruction input unit arranged to accept input of an instruction from a user; and
an image forming unit arranged to print an image corresponding to a print file; wherein
the communication control unit is programmed to poll the server system at a certain time interval; and
when the instruction input unit accepts a start instruction to start operating in a processing mode in which a print file to be printed is acquired from the server system and print processing is executed on the print file, the communication control unit is programmed to make a polling time interval for the server system shorter than before the start instruction is accepted.

8. The server system according to claim 1, further comprising a print processing control unit programmed to transmit the print file to the certain printer in response to data received from the certain printer.

9. The server system according to claim 1, wherein the certain printer is connected to an intranet that is protected by a firewall, and the intranet is connected to the internet via the firewall.

10. The server system according to claim 1, wherein the server system is constituted by a single device or plural devices connected to each other so as to be capable of communicating with one another.

11. The server system according to claim 1, wherein the server system is constituted by at least one hardware device or a combination of at least one hardware device and software executed thereon.

12. The server system according to claim 1, further comprising a communication unit including a network interface that communicates with another device connected via the internet and communicates with a storage device and a relational database management system.

13. The server system according to claim 1, wherein the communication control unit, the instruction accepting unit, and the print file acquiring unit define a control unit that includes processor and a storage unit and is programmed to perform the functions of the communication control unit, the instruction accepting unit, and the print file acquiring unit.

14. The server system according to claim 8, wherein the control unit further comprises a print processing control unit programmed to transmit the print file to the certain printer in response to data received from the certain printer.

15. The server system according to claim 1, wherein the communication control unit is programmed to receive a polling signal from the certain printer that includes a serial number of the certain printer and to perform a preset response process in accordance with the serial number of the certain printer, and the communication control unit is programmed to change content of a polling response for the certain printer in accordance with a notification received from a print processing control unit.

16. The server system according to claim 1, wherein the instruction accepting unit is programmed to transmit data of a display screen showing a list of document files managed by the server system to a client device, and to accept from a user of the server system a selection instruction and a print instruction for a document file to be printed.

17. The server system according to claim 1, wherein the instruction accepting unit is programmed to perform a user authentication process for a user who has accessed the server system via a client device.
